(19) United States
(12) Patent Application Publication
(10) Pub. No.: US 2024/0385587 A1
(43) Pub. Date: Nov. 21, 2024

(54) SOLDERING PROGRAM GENERATION

(71) Applicant: Illinois Tool Works Inc., Glenview, IL (US)

(72) Inventors: Gerardus Johannes Adrianus Maria DIEPSTRATEN, Dongen (NL); Antonie Cornelis COLIJN, Nieuwendijk (NL)

(21) Appl. No.: 18/576,934

(22) PCT Filed: Jun. 30, 2022
(86) PCT No.: PCT/US2022/035745

§ 371 Date: Jan. 5, 2024

(30) Foreign Application Priority Data
Jul. 5, 2021 (EP) 21183828.9

(51) Int. Cl. G05B 19/4093; B23K 1/20; B23K 101/42; G05B 23/02

(52) U.S. Cl. CPC G05B 19/4093; B23K 1/203; G05B 23/0283; B23K 2101/42

(57) ABSTRACT

Example processes for generating a program for applying flux to, and/or for soldering components onto, an electronics board, the program including manufacturing settings, involves: a) obtaining an image of the board: b) determining board properties from the image of the board, the board properties including: a location or locations of at least one soldering spot on the board, wherein the at least one soldering spot includes an aperture through which a part of an electronic component extends or is extendable, to be soldered to the board; and c) determine the manufacturing settings based upon the determined board properties.

### TECHNICAL FIELD

The disclosure relates to generating a solder program for a soldering process. In particular, the disclosure relates to generating a solder program for a soldering process, the solder program being applied to a soldering machine to apply flux to, and/or to solder, an electronics board.

### BACKGROUND

Selective soldering machines are used to solder electronics components to boards, such as to printed circuit boards (PCBs). The boards pass through the machine and undergo a soldering process to connect the components to the board. The soldering process typically includes the application of flux to the joints between the components and the board, pre-heating the components and the board, and applying solder to the connections between the components and the board.

To control the soldering process a program is produced and provided to the soldering machine. This program contains information relating to the board layout, for example the locations of the solder joints on the board, as well as the required machine settings.

The information relating to the board layout is sometimes provided as vector-based data, for example Gerber data. However, this data is not always available, as it is often difficult and expensive to produce. Vector-based data is also difficult to change if the design of the board changes. Furthermore, providing vector-based data does not eliminate the requirement for user intervention, such as to check the data against the actual board layout, at least periodically.

More often, joint locations are provided by obtaining a technical drawing or 3D model, or by taking a scan of the board, and loading this drawing, model or scan into software to produce the solder program, where the software automatically recognises the locations of the holes and determines default flux and soldering conditions. However, this process usually requires manual input, for example to adjust the measurements to better represent the actual dimensions of the board. This is time consuming and is prone to errors.

Once the board layout and dimensions are determined, the software may look up the manufacturing settings from a library. The manufacturing settings typically include flux and soldering conditions, which, in turn, may include flow speed of the flux, the amount of flux, the speed with which flux is applied, the speed with which solder is applied, and the amount, or height, of solder applied, amongst other parameters. Other machine parameters, such as preheat temperature and time, solder temperature, and settings relating to gas flow and power used for de-bridging, might be programmed into the software separately, or might be determined by the software automatically. However, because the properties of the board are determined from vector-based data, a drawing, a model, or a scan, these manufacturing settings are generally consistent for all boards of the same design. Therefore, no account is made for any differences between each board and the design which has been loaded into the software. This can lead to suboptimal manufacturing settings being used for each board, for example too much or too little solder being applied.

The present disclosure aims to overcome at least some of the aforementioned limitations.

### SUMMARY

According to an aspect of the present disclosure, there is provided a process for generating a program, or recipe, for applying flux to, and/or for soldering components onto, an electronics board, the program comprising manufacturing settings and the process comprising the steps of:
a) obtain an image of the board;
b) determine board properties from the image of the board, the board properties comprising:
   a location or locations of at least one soldering spot on the board, wherein the soldering spot comprises an aperture through which a part of an electronic component extends or is extendable to be soldered to the board;
c) determine the manufacturing settings based upon the determined board properties.

The board properties may further comprise at least one cross-sectional dimension of each aperture. The cross-sectional dimension may be measured in the plane of the board. The cross-sectional dimension may be a diameter.

The image may be obtained using an image capturing device. The image capturing device may be a camera.

The process may be performed on each board. The process may be performed on each board of a plurality of electronics boards. The process may be performed before flux is applied to the board. The process may be performed before solder is applied to the board. The process may be performed after flux is applied to the board.

The manufacturing settings may comprise settings relating to the application of flux and/or to the application of solder.

Determining manufacturing settings in step c) may comprise using an information repository. The information repository may comprise a datasheet. The information repository may comprise a library. Manufacturing settings may be provided which correspond to the board properties, wherein the information repository contains properties of a plurality of flux materials and/or a plurality of solder materials corresponding to various board properties.

The process may comprise a further step: d) determine the thermal mass of the board and use the thermal mass and the manufacturing settings, for example an amount of flux required at each soldering spot, to generate a preheat temperature profile for the board. The machine settings may include any number of: a preheat temperature profile for the board; a flux application route; a flux application speed; a flux application amount; a flux application temperature; a flux application flow rate; a solder application route; a solder application height; a solder application temperature; a drag speed of the board; a debridging gas flow rate, e.g. a nitrogen gas flow rate; solder nozzle dimensions.

The debridging gas may be nitrogen. Preheating may be via infra-red lamps or via forced convection.

Determining the thermal mass of the board may comprise automatically obtaining technical information from a technical drawing or 3D model of the board.

The technical information may include any number of the thermal mass, dimensions of copper layers, number of copper layers, a board thickness, or dimensions of the board.

The at least one soldering spot may be at least two soldering spots. The board properties determined in step b) may further comprise a distance between the apertures of at least two soldering spots. The at least two soldering spots may be adjacent. The distance between one of the apertures and adjacent apertures may be used to determine an optimum solder application route or an optimum debridging gas flow rate.

The process may further comprise the step of comparing the board properties to expected board properties. The expected board properties may be determined using a technical drawing. A determination of if the difference between the board properties and the expected board properties are within a predetermined tolerance may be implemented. If the difference is outside of the pre-determined tolerance an alarm, alert or warning may be provided. If the difference is outside of the pre-determined tolerance the process may be paused or stopped. The difference may be recorded to monitor quality of the board and/or of the process. For example, a gradual increase in the difference may indicate reduced quality in board manufacture.

According to another aspect of the present disclosure, there is provided a method of generating programs for applying flux to, and/or for soldering components onto, first and second electronics boards, the method comprising the steps of:
applying the aforementioned process to generate an individual program for applying flux to, and/or for soldering components onto, the first electronics board; and
applying the aforementioned process to generate an individual program for applying flux to, and/or for soldering components onto, the second electronics board.

According to the present disclosure, there is provided a method of generating programs for applying flux to, and/or for soldering components onto, a plurality of electronics boards, the method comprising applying the aforementioned process to generate an individual program for applying flux to, and/or for soldering components onto, each of the plurality of electronics boards.

The plurality of electronics boards may be the electronics boards in a batch of electronics boards. The plurality of electronics boards may be selected from the electronics boards in a batch of electronics boards. The batch of electronics boards may be a set of electronics boards which have the same design of layout of components. The batch of electronics boards may be processed in a soldering machine, e.g. a selective soldering machine.

According to another aspect of the present disclosure, there is provided a method of maintaining a soldering machine, the method comprising logging the determined properties or settings of the aforementioned process. The logged properties or settings might be used to predict a lifecycle of components of the machine, or to predict a lifecycle of the machine.

According to another aspect of the disclosure there is provided a process for generating a program for applying flux to, and/or for soldering components onto, each of a plurality of electronics boards, the program comprising manufacturing settings and the process comprising the steps of:
a) obtain an image of each board;
b) determine board properties for each board from the image of the respective board, the board properties comprising:
   a location or locations of at least one soldering spot on the respective board, wherein the at least one soldering spot comprises an aperture through which a part of an electronic component extends or is extendable, to be soldered to the respective board;
c) determine the manufacturing settings based upon the determined board properties.

### BRIEF DESCRIPTION OF DRAWINGS

Example disclosures are illustrated in the accompanying drawings, in which:

FIG. 1 illustrates a flowchart for the generation of a program for soldering components onto an electronics board; and

FIG. 2 is a schematic of an electronics board and a camera.

### DESCRIPTION

The example provided herein relates to a process 1 for generating a program, or recipe, for applying flux to, and/or for soldering components onto, an electronics board 2.

The process 1 is intended for use in a selective soldering machine. However, the process 1 may be used with any soldering machine or with any flux application machine. In the described example the process 1 is described with reference to a soldering machine.

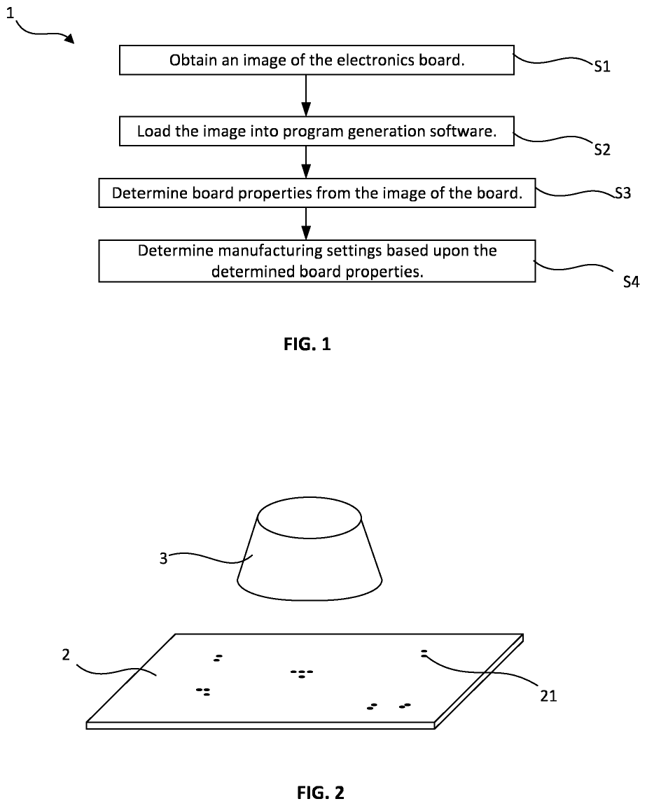

Referring to FIGS. 1 and 2, FIG. 1 shows a flowchart of the process 1, FIG. 2 shows a schematic of the electronics board 2 and an image capturing device 3.

The process 1 takes place before a fluxing and/or soldering process is applied to the board 2 in a soldering machine (not shown). The process may take place after the board 2 enters a soldering machine or before the board 2 enters the soldering machine. The process 1 may be applied to each board individually. The process 1 comprises manufacturing settings which are used by the soldering machine for applying flux to the electronics board 2 and/or for soldering components onto the electronics board 2.

A first step S1 of the process 1 is to obtain an image of the board 2. In this example the image is obtained using the image capturing device 3 shown in FIG. 2. In this example the image capturing device 3 is a camera, but any other image capturing device may be used.

In this example, in a second step S2, the obtained image is loaded into program generation software. The software determines board properties from the image of the board 2 in a third step S3. One of the board properties to be determined is the location of each of at least one soldering spot 21, on the board 2. In this example there are a plurality of soldering spots 21. Each soldering spot 21 comprises an aperture through which parts of electrical components extend or are extendable to be soldered to the board. In this example the locations of the plurality of soldering spots 21 are stored as position coordinates. In this example, the coordinates are recorded into the software.

Another board property to be determined at step S3 is at least one cross-sectional dimension of the aperture of each soldering spot 21. The cross-sectional dimension is measured in the plane of the board. In other words, the cross-sectional dimension is a dimension of the profile of the aperture. In this example the apertures are circular in cross-section, and so the at least one cross-sectional dimension is the diameter of the aperture. However, it will be appreciated that any cross-sectional shape of aperture is envisaged. In this example, the at least one cross-sectional dimension of each aperture is recorded into the software. At a fourth step S4, manufacturing settings are determined, based upon the board properties determined in the third step S3.

The process 1 improves the efficiency of determining manufacturing settings for boards 2, as each board 2 is scanned individually. This means that complex data for each board is not required. This also negates the necessity to provide complex data relating to the design of the board 2 and negates the necessity to manually check the data against the board 2. Furthermore, this means that the process may account for discrepancies between the design of the board and the actual layout of each board, as each board can be measured individually.

Further board properties may also be determined in the third step S3. It will be appreciated that any properties which are determinable from an image of the board 2 may be determined at the third step S3, and that all such possible properties are not described herein.

In this example, the board properties determined at the third step S3 include a thermal mass of the board 2. The thermal mass is calculated by providing thermal properties of the board to the software, and using the image capturing device 3 to determine planar dimensions. The thickness of the board is either inputted into the software separately, for example from technical data or a model, or a thickness gauge, for example a laser thickness gauge, is used to measure the thickness dimensions. The planar and thickness dimensions are then used to determine the volume of the board 2, and the thermal properties are used alongside the volume to determine the thermal mass of the board 2.

Alternatively, the thermal mass may be inputted into the software manually. The thermal mass may be inputted manually and then adjusted based upon the planar dimensions measured at the third step S3.

Alternatively, the thermal mass of the board may be determined automatically from a technical drawing and/or 3D model of the board 2. The thermal mass may be directly obtained from the technical drawings and/or 3D model also, in that a thermal mass value is present on the technical drawings and/or 3D model, for example as a visually identifiable code.

Otherwise, the thermal mass may be calculated from information stored in the software, present on the technical drawings and/or 3D model, or which is stored in the software but is identified using information in the technical drawing and/or 3D model. The information may comprise at least one of dimensions of copper layers, number of copper layers, a board thickness, or dimensions of the board.

In this example, the thermal mass is used to determine manufacturing settings such as, but not limited to, the amount of flux or solder at each soldering spot 21, the speed of application of solder at each soldering spot 21, or preheating settings for the board 2. By way of example, the solder speed may be slower at areas with a high thermal mass. By using the thermal mass to determine preheater settings and the amount of flux and/or solder, board warpage is minimised, as large variations in heat across the planar dimension of the board can be avoided.

In this example the board properties also include a distance between apertures, which is calculated from the coordinates of the locations of the apertures.

In another example, any number of properties of the board 2 may be stored in an encoded graphic (not shown) on the board 2. An image of the encoded graphic is captured by the image capturing device 3 and decoded by the software to determine the information stored therein. The decoded information pertains to one or more board properties.

By way of another example, each board may comprise an identification code, or number (not shown). The software determines the identification of the board from the image captured of the board 2, and one or more board properties which are stored in the software are therefore attributed to the board 2.

As illustrated in these examples, some board properties are determined directly from the image captured in the first step S1, and some may be inputted into the software separately. The software may combine information present in the software with those determined from the image.

Once the necessary board properties have been determined, the manufacturing settings are determined based upon the determined board properties. In this example the manufacturing settings are determined from an information repository (not shown), at the fourth step S4, in this example. The information repository may comprise a library, at least one datasheet, and/or any other information store, containing manufacturing settings relating to a plurality of flux materials and a plurality of solder materials. The data relating to the flux or solder materials correspond to the board properties determined at the third step S3. In other words, the board properties are used to identify or to calculate the manufacturing settings using information stored in the information repository.

In this example the manufacturing settings relate to the application of flux and/or to the application of solder to the board 2. For example, the manufacturing settings may include one or more of a type, a temperature, or an amount of flux to be applied to the board 2 before the components are soldered thereto. Alternatively, or additionally, the manufacturing settings may include one or more of a type, a temperature, or an amount of solder to be applied to solder the components to the board 2. It will be appreciated that other manufacturing settings may be present in the information repository, such that these can be selected by the software correspondingly to the board properties.

The manufacturing settings may be determined based upon algorithms. For example, the manufacturing settings may be interpolated between data which are stored in the information repository, the data corresponding to board properties which are different from the board properties obtained from the image. Alternatively, the terms of an algorithm or equation may be stored in the information repository, and the board properties provide the variables to the algorithm or formula.

In this example, machine settings are determined for soldering components to the board 2. The machine settings include, but are not limited to, a flux application route, a solder application route, a drag speed of the board 2, a debridging gas flow rate and/or solder nozzle dimension. Some machine settings may be adjusted automatically by the software, and some machine settings may require a user to make adjustments. By way of an example, where a board 2 has a lot of free space, as calculated using the distance between apertures, a greater solder nozzle diameter may be used, as there is less risk of bridging occurring between adjacent soldering spots 21. The distance between apertures, in this example, is also used to determine the flux application route, the solder application route, and the drag speed of the board 2. The solder application route and the drag speed of the board 2 are determined to reduce the risk of bridging between soldering spots 21.

In another example there is provided a method of maintaining a soldering machine using the manufacturing settings and/or the machine settings in the process 1. For example, the software may log how much solder and/or flux is used per board 2. The software may then be able to predict when the stores of flux and/or solder must be replaced. The software may also identify discrepancies in the usage rate of the flux and/or solder compared to those predicted based upon the manufacturing and/or machine settings. These discrepancies may indicate problems with the boards 2, the machine, or the process 1. The software may also calculate the cycle time of the boards 2 based upon the manufacturing and/or machine settings. The cycle time may be used to plan workflow using the machine, and also to schedule maintenance or inspections. For example, the machine may require maintenance or inspection after a certain number of boards 2 have been soldered, and so the software is able to calculate when maintenance or inspection must be performed. The software may also calculate the output rate of the machine and identify discrepancies between the calculated output rate and the realised output rate. These discrepancies may indicate problems with the boards 2, the machine, or the process 1. The software may calculate how frequently other consumables must be replaced, for example nitrogen gas for debridging. The software may also calculate the quantity of consumables used per board 2, for example the amount of solder, flux, power and/or debridging gas (e.g. nitrogen) used per board.

In another example, the board properties, which are obtained from the image of the board, are compared with expected board properties in a method for ensuring quality of the board and/or the processes. A difference between the board properties and expected board properties is determined to be within or outside of a predetermined tolerance. If the difference is outside of the predetermined tolerance then suitable action is taken, such as providing an alarm, a warning or an alert, or pausing or stopping the process. The differences may be recorded to monitor quality of the boards and of the process. For example, if any differences gradually increase, then this may suggest that manufacturing quality of the boards is decreasing.

The following numbered clauses are also provided:

Clause 1. A process for generating a program for soldering components onto an electronics board, the program comprising manufacturing settings and the process comprising the steps of:
a) obtain an image of the board;
b) determine board properties from the image of the board, the board properties comprising:
   a location or locations of at least one soldering spot on the board, wherein the at least one soldering spot comprises an aperture through which a part of an electronic component extends or is extendable, to be soldered to the board;
c) determine the manufacturing settings based upon the determined board properties.

Clause 2. A process according to clause 1, wherein the board properties further comprise at least one cross-sectional dimension of the aperture.

Clause 3. A process according to clause 2, wherein the at least one cross-sectional dimension is a diameter.

Clause 4. A process according to any preceding clause, wherein the manufacturing settings comprise settings relating to the application of flux and to the application of solder.

Clause 5. A process according to any preceding clause, wherein determining manufacturing settings in step c) comprises using an information repository, for example a datasheet or a library, to provide the manufacturing settings corresponding to the board properties, wherein the information repository contains properties of a plurality of flux materials and a plurality of solder materials corresponding to various board properties.

Clause 6. A process according to any preceding clause further comprising the step:
d) determine the thermal mass of the board and use the thermal mass and the manufacturing settings, for example an amount of flux required at each soldering spot, to generate machine settings, for example a preheat temperature profile for the board, a flux application route, a solder application route, a drag speed of the board, a debridging gas flow rate and/or solder nozzle dimensions.

Clause 7. A process according to clause 6 wherein determining the thermal mass of the board comprises automatically obtaining technical information from a technical drawing or 3D model of the board.

Clause 8. A process according to clause 7 wherein the technical information includes any number of the thermal mass, dimensions of copper layers, number of copper layers, a board thickness, or dimensions of the board.

Clause 9. A process according to any preceding clause, wherein the at least one soldering spot is at least two soldering spots, and the board properties determined in step b) further comprises a distance between the apertures of the at least two soldering spots.

Clause 10. A method of generating programs for soldering components onto first and second electronics boards, the method comprising the steps of:
applying the process of any preceding clause to generate an individual program for soldering components onto the first electronics board; and
applying the process of any preceding clause to generate an individual program for soldering components onto the second electronics board.

Clause 11. A method of generating programs for soldering components onto a plurality of electronics boards, the method comprising applying the process of any of clauses 1 to 9 to generate an individual program for soldering components onto each of the plurality of electronics boards.

Clause 12. A method of maintaining a soldering machine, the method comprising logging the determined properties or settings of the process according to any of clauses 1 to 9, the logged properties or settings being used to predict a lifecycle of components of the machine, or to predict a lifecycle of the machine.

1-22. (canceled)

23. A process for generating a program for applying flux to, or for soldering components onto, an electronics board, the program comprising manufacturing settings and the process comprising:
obtaining an image of the board;
determining board properties from the image of the board, the board properties comprising one or more locations of at least one soldering spot on the board, wherein the at least one soldering spot comprises an aperture through which a part of an electronic component extends or is extendable, to be soldered to the board; and
determining the manufacturing settings based upon the determined board properties.

24. The process according to claim 23, wherein the board properties further comprise at least one cross-sectional dimension of the aperture.

25. The process according to claim 24, wherein the at least one cross-sectional dimension is a diameter.

26. The process according to claim 23, wherein the manufacturing settings comprise settings relating to at least one of the application of flux or the application of solder.

27. The process according to claim 23, wherein the determining of manufacturing settings comprises using an information repository to provide the manufacturing settings corresponding to the board properties, wherein the information repository contains properties of at least one of a plurality of flux materials or a plurality of solder materials corresponding to different board properties.

28. The process according to claim 23 further comprising:
determining the thermal mass of the board; and
using the thermal mass and the manufacturing settings to generate machine settings, the machine settings comprising at least one of: a preheat temperature profile for the board; a flux application route; a flux application speed; a flux application amount; a flux application temperature; a flux application flow rate; a solder application route; a solder application height; a solder application temperature; a drag speed of the board; a debridging gas flow rate; or solder nozzle dimensions.

29. The process according to claim 28, wherein the determining of the thermal mass of the board comprises automatically obtaining technical information from a technical drawing or 3D model of the board.

30. The process according to claim 29, wherein the technical information includes one or more of: the thermal mass, dimensions of copper layers, number of copper layers, a board thickness, or dimensions of the board.

31. The process according to claim 23, wherein the at least one soldering spot is at least two soldering spots, and the determined board properties further comprise a distance between the apertures of the at least two soldering spots.

32. The process according to claim 23, further comprising comparing the board properties to expected board properties to determine if the difference between the board properties and the expected board properties are within a predetermined tolerance.

33. A method of generating programs for applying flux to, and/or for soldering components onto, first and second electronics boards, the method comprising:
applying the process of claim 23 to generate an individual program for at least one of applying flux to the first electronics board or soldering components onto the first electronics board; and
applying the process of claim 23 to generate an individual program for applying flux for at least one of applying flux to the first electronics board or soldering components onto the second electronics board.

34. A method of generating programs for applying flux to, and/or for soldering components onto, a plurality of electronics boards, the method comprising applying the process of claim 23 to generate an individual program for at least one of applying flux to the plurality of electronics boards or soldering components onto the plurality of electronics boards.

35. A method of maintaining a soldering machine, the method comprising logging the determined properties or settings of the process of claim 23, and predicting a lifecycle of at least one of the soldering machine or a lifecycle of components of the soldering machine based on the logged properties or settings.

36. A process for generating a program for applying flux to, and/or for soldering components onto, each of a plurality of electronics boards, the program comprising manufacturing settings and the process comprising:
obtaining an image of each board;
determining board properties for each board from the image of the respective board, the board properties comprising a location or locations of at least one soldering spot on the respective board, wherein the at least one soldering spot comprises an aperture through which a part of an electronic component extends or is extendable, to be soldered to the respective board; and
determining the manufacturing settings based upon the determined board properties.

37. The process according to claim 36, wherein the board properties further comprise at least one cross-sectional dimension of the aperture.

38. The A process according to claim 37, wherein the at least one cross-sectional dimension is a diameter.

39. The process according to claim 36, wherein the determining of the manufacturing settings comprises using an information repository to provide the manufacturing settings corresponding to the board properties, wherein the information repository contains properties of one or more of a plurality of flux materials or a plurality of solder materials corresponding to different board properties.

40. The process according to claim 36, further comprising:
determining the thermal mass of each board;
using the thermal mass and the manufacturing settings to generate machine settings, the machine settings comprising at least one of: a preheat temperature profile for the board; a flux application route; a flux application speed; a flux application amount; a flux application temperature; a flux application flow rate; a solder application route; a solder application height; a solder application temperature; a drag speed of the board; a debridging gas flow rate; or solder nozzle dimensions.

41. The process according to claim 40, wherein the determining of the thermal mass of the board comprises automatically obtaining technical information from a technical drawing or 3D model of the board.

42. The process according to claim 41, wherein the technical information includes at least one of the thermal mass, dimensions of copper layers, number of copper layers, a board thickness, or dimensions of the board.
